(19) United States
(12) Patent Application Publication
(10) Pub. No.: US 2007/0233663 A1
(43) Pub. Date: Oct. 4, 2007

(54) METHOD, APPARATUS, AND COMPUTER PROGRAM PRODUCT FOR SEARCHING INFORMATION

(75) Inventors: Junko Ami, Tokyo (JP); Yasuyuki Masai, Kanagawa (JP); Takehide Yano, Kanagawa (JP); Hisayoshi Nagae, Kanagawa (JP); Kazuhiko Abe, Tokyo (JP); Tetsuya Sakai, Tokyo (JP); Hideki Tsutsui, Kanagawa (JP); Kazutaka Ohigashi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/680,914

(22) Filed: Mar. 1, 2007

(30) Foreign Application Priority Data
Mar. 30, 2006 (JP) 2006-095939

(51) Int. Cl. G06F 17/30

(52) U.S. Cl. 707/3

(57) ABSTRACT

An acquiring unit acquires a first search criterion from outside. A first searching unit extracts a first search result that satisfies the first search criterion from a storing unit that stores information to be searched. A first output unit outputs the first search result to a first output device. A changing unit changes the first search criterion to a second search criterion based on a predetermined condition. A second searching unit extracts a second search result that satisfies the second search criterion from the storing unit. A second output unit outputs the second search result to a second output device that is different from the first output device.

### CROSS-REFERENCE TO RELATED APPLICATIONS

This application is based upon and claims the benefit of priority from the prior Japanese Patent Application No. 2006-95939, filed on Mar. 30, 2006; the entire contents of which are incorporated herein by reference.

### BACKGROUND OF THE INVENTION

1. Field of the Invention

The present invention relates to a method, an apparatus, and a computer program product for searching information and outputting a search result.

2. Description of the Related Art

Conventionally, apparatuses that conduct information searches using voice/audio interactions are known. Such an apparatus outputs a result of a search in the form of an image or audio. An advantageous feature of images is that they can be used to display a large amount of information at one time because of their ability to allow the information to be viewed at a glance. An advantageous feature of audio is that it can be used to provide information compactly within a range of human speech intelligibility.

In principle, information searches are conducted according to one or more criteria specified by a user. However, another type of apparatus is known that, when the system is unable to output information desired by a user as a result of an information search, partially broadens the criteria specified by the user and searches for information satisfying the broadened criteria so that a result of some sort is output and so that a situation where nothing is output can be avoided. (For example, see JP-A 2001-249930 (KOKAI).) Also, another arrangement is known where, even if the system is able to output information desired by a user, the system presents relevant information, if any, to the user.

However, when results of a search are output in the form of an image, if a result of a search conducted based on specified criteria that are specified by a user and a result of a search conducted based on criteria obtained by broadening the specified criteria are displayed on one screen, a larger amount of information is displayed on the screen. This may prevent the user from identifying which piece of information is the information the user needs. When results of a search are output in the form of audio, the user needs to listen to a larger amount of information. This may prevent the user from obtaining necessary information properly.

As explained above, when the system outputs a result of a search conducted based on criteria that are different from the criteria specified by a user, if a result of a search conducted based on the criteria specified by the user and a result of a search conducted based on the criteria different from the specified criteria are output in an equal manner, a problem arises where it is difficult to identify desired pieces of information from among pieces of information that have been output.

### SUMMARY OF THE INVENTION

An apparatus for searching information, according to one aspect of the present invention, includes an acquiring unit that acquires a first search criterion from outside; a storing unit that stores information to be searched; a first searching unit that extracts a first search result that satisfies the first search criterion from the storing unit; a first output unit that outputs the first search result to a first output device; a changing unit that changes the first search criterion to a second search criterion based on a predetermined condition; a second searching unit that extracts a second search result that satisfies the second search criterion from the storing unit; and a second output unit that outputs the second search result to a second output device having an output format different from an output format of the first output device.

A method of searching information, according to another aspect of the present invention includes acquiring a first search criterion from outside; extracting a first search result that satisfies the first search criterion from a storing unit that stores information to be searched; outputting the first search result to a first output device; changing the first search criterion to a second search criterion based on a predetermined condition; extracting a second search result that satisfies the second search criterion from the storing unit; and outputting the second search result to a second output device having an output format different from an output format of the first output device.

A computer program product according to still another aspect of the present invention causes a computer to perform the method according to the present invention.

### BRIEF DESCRIPTION OF THE DRAWINGS

FIG. 1 is a block diagram of a functional configuration of an information searching apparatus according to an embodiment of the present invention;

FIG. 2 is a schematic diagram of an external appearance of the information searching apparatus according to the present embodiment;

FIG. 3 is a schematic diagram of a data structure of an extended-keyword table;

FIG. 4 is a schematic diagram of a data structure of an evaluation-element table;

FIG. 5 is a schematic diagram of a data structure of a genre table;

FIG. 6 is a schematic diagram of a data structure of a preference table;

FIG. 7A is a schematic diagram for explaining scores given to restaurants;

FIG. 7B is a schematic diagram for explaining an evaluation method for search results;

FIG. 8 is a flowchart of an information searching processing performed by the information searching apparatus 10;

FIG. 9 is a flowchart of a detailed procedure in a special search criteria processing;

FIG. 10 is a schematic diagram of an example of the special search criteria processing;

FIG. 11 is a schematic diagram of search results obtained from the example shown in FIG. 10;

FIG. 12 is a schematic diagram of another example of the special search criteria processing. This example is obtained by deleting a different restrictive portion from the input search criteria that are the same as the input search criteria shown in FIG. 10;

FIG. 13 is a schematic diagram of search results obtained from the example shown in FIG. 12;

FIG. 14 is a flowchart of a detailed procedure in the special search criteria processing during which special search criteria are generated by extending the meaning of a keyword;

FIG. 15 is a schematic diagram of an example of the special search criteria processing during which special search criteria are generated by extending the meaning of a keyword;

FIG. 16 is a schematic diagram of search results obtained from the example shown in FIG. 15;

FIG. 17 is a flowchart of a detailed procedure in the special search criteria processing during which special search criteria are generated by changing the meaning of a keyword;

FIG. 18 is a schematic diagram of an example of the special search criteria processing during which special search criteria are generated by changing the meaning of a keyword;

FIG. 19 is a schematic diagram of search results obtained from the example shown in FIG. 18;

FIG. 20 is a flowchart of a detailed procedure in the special search criteria processing during which a special search is conducted using a search history as a search target range;

FIG. 21 is a schematic diagram of an example of the special search criteria processing (step S104) during which a special search is conducted using a search history as a search target range;

FIG. 22 is a schematic diagram of results of a search conducted by using a search history as a search target range, and also based on special search criteria obtained by extending input search criteria;

FIG. 23 is a flowchart of a detailed procedure in the special search criteria processing during which special search criteria are generated based on a user's preference;

FIG. 24 is a schematic diagram of an example of a processing for generating special search criteria based on a user's preference;

FIG. 25 is a schematic diagram of search results obtained from the example shown in FIG. 24;

FIG. 26 is a flowchart of a detailed procedure in the special search criteria processing during which special search criteria are generated by changing a keyword;

FIG. 27 is a schematic diagram of an example of a processing for generating special search criteria by changing a keyword;

FIG. 28 is a schematic diagram of search results obtained from the example shown in FIG. 27; and

FIG. 29 is a schematic diagram of a hardware configuration of the information searching apparatus according to the present embodiment.

### DETAILED DESCRIPTION OF THE PREFERRED EMBODIMENTS

Exemplary embodiments of the present invention will be explained in detail below with reference to the accompanying drawings. The present invention is not limited to the exemplary embodiments.

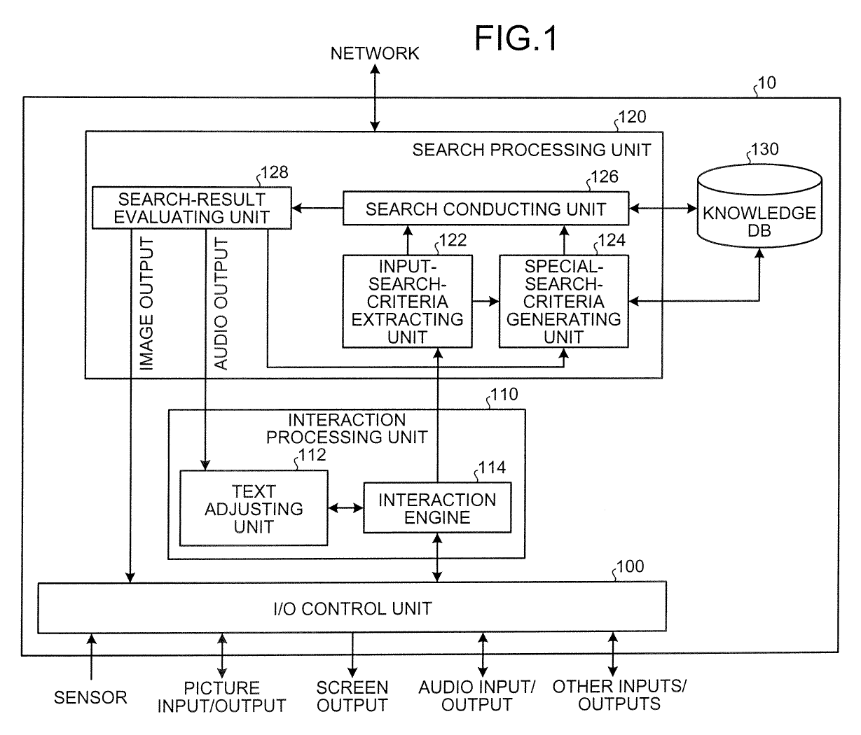

FIG. 1 is a block diagram of a functional configuration of an information searching apparatus 10 according to an embodiment of the present invention. The information searching apparatus 10 includes an input/output (I/O) control unit 100, an interaction processing unit 110, a search processing unit 120, and a knowledge database (DB) 130.

The I/O control unit 100 controls exchange of information between the inside and the outside of the information searching apparatus 10. The I/O control unit 100 controls not only inputs and outputs of audio and images but also inputs and outputs of data from various devices including a sensor and a keyboard. The I/O control unit 100 also selects input and output destinations, for example, which piece of information is output from which device. In addition, the I/O control unit 100 determines the timing of inputs and outputs defining that, for example, audio is output after it is detected by a line-of-sight sensor (not shown) that the user has taken a glance at an output on the screen.

The interaction processing unit 110 performs a processing for realizing smooth interactions. The interaction processing unit 110 includes a text adjusting unit 112, and an interaction engine 114. When having obtained a search request from the I/O control unit 100, the interaction engine 114 passes control to the search processing unit 120. When having obtained an audio output request from the search processing unit 120, the interaction engine 114 adjusts the contents of an output so that the output is in a form that is suitable for an audio output and passes control to the I/O control unit 100. An example of a form that is suitable for an audio output is an output in a short sentence. It is not necessary for image inputs and image outputs to go through the interaction processing unit 110.

The knowledge DB 130 stores therein various dictionaries and data as well as a history of the use of the system by the user and a profile of the user. Also, as user information, the knowledge DB 130 stores therein a history of searches that have previously been conducted by the user. The knowledge DB 130 is able to store therein various types of knowledge. When some information to be used by the search processing unit 120 is not stored in the knowledge DB 130, the information may be obtained from a network to which the information searching apparatus 10 is connected. The knowledge DB 130 according to the present embodiment functions as an information storing unit and a criterion storing unit.

The search processing unit 120 conducts an information search according to one or more search criteria that have been input by the user. The search processing unit 120 includes an input-search-criteria extracting unit 122, a special-search-criteria generating unit 124, a search conducting unit 126, and a search-result evaluating unit 128.

The input-search-criteria extracting unit 122 obtains the input search criteria that have been input by the user. To be more specific, for example, when an inquiry to request information is input by the user in the form of audio, the input-search-criteria extracting unit 122 extracts input search criteria from the contents of the input. The input search criteria according to the present embodiment correspond to a first search criterion.

The special-search-criteria generating unit 124 generates special search criteria based on the input search criteria extracted by the input-search-criteria extracting unit 122. When generating the special search criteria, the special-search-criteria generating unit 124 refers to the information stored in the knowledge DB 130 or the like. The special-search-criteria generating unit 124 according to the present embodiment functions as a search criterion changing unit. The special search criteria according to the present embodiment correspond to a second search criterion.

The search conducting unit 126 conducts a search, based on the input search criteria extracted by the input-search-criteria extracting unit 122 and the special search criteria generated by the special-search-criteria generating unit 124. The information being a target of the search may be the information stored in the knowledge DB 130, or may be obtained from the network to which the information searching apparatus 10 is connected. The search conducting unit 126 extracts information that corresponds to the search criteria from the knowledge DB 130 or from the network. The search conducting unit 126 according to the present embodiment functions as a first searching unit and a second searching unit.

The search-result evaluating unit 128 evaluates search results obtained by the search conducting unit 126. To be more specific, for example, the search-result evaluating unit 128 arranges the search results based on the input search criteria in the order of their scores. Also, the search-result evaluating unit 128 selects a piece of information from among a plurality of pieces of information that are obtained as the search results for the special search criteria, based on the search results for the input search criteria and the search results for the special search criteria. To be more specific, the search-result evaluating unit 128 selects information other than the information that is duplicated between the search results based on the input search criteria and the search results based on the special search criteria. The search-result evaluating unit 128 according to the present embodiment functions as a search score calculating unit and a search-result evaluating unit. In the description above, the search-result evaluating unit 128 selects a piece of information from among a plurality of pieces of information. However, alternatively, the search-result evaluating unit 128 may present the plurality of pieces of information without any selection process. Furthermore, when no search result has been obtained, the search-result evaluating unit 128 may generate another set of special search criteria after having obtained feedback on the search result.

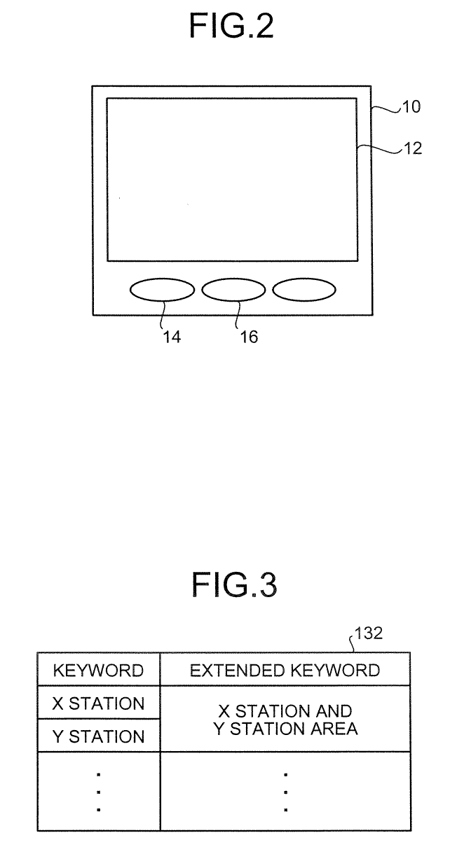

FIG. 2 is a schematic diagram of an external appearance of the information searching apparatus 10. The information searching apparatus 10 includes a display screen 12, a speaker 14, and a microphone 16. When the user speaks into the microphone 16, the I/O control unit 100 obtains audio information that corresponds to the speech. Information that is related to search results or the like and has been output by the I/O control unit 100 is output from the display screen 12 and the speaker 14. The display screen 12 and the speaker 14 according to the present embodiment function as a first output device and a second output device, respectively.

FIG. 3 is a schematic diagram of a data structure of an extended-keyword table 132 stored in the knowledge DB 130. The extended-keyword table 132 stores therein keywords each of which may be obtained from a user as a search criterion in correspondence with extended keywords that are obtained by extending the meanings of the keywords. For example, in correspondence with a keyword “X Station”, an extended keyword “X Station and Y Station Area”, which has a broader range than “X Station”, is obtained.

As explained above, in the extended-keyword table 132, keywords are stored in correspondence with extended keywords. Thus, the special-search-criteria generating unit 124 generates extended search criteria that serve as special search criteria being in correspondence with the obtained input search criteria, by referring to the extended-keyword table 132.

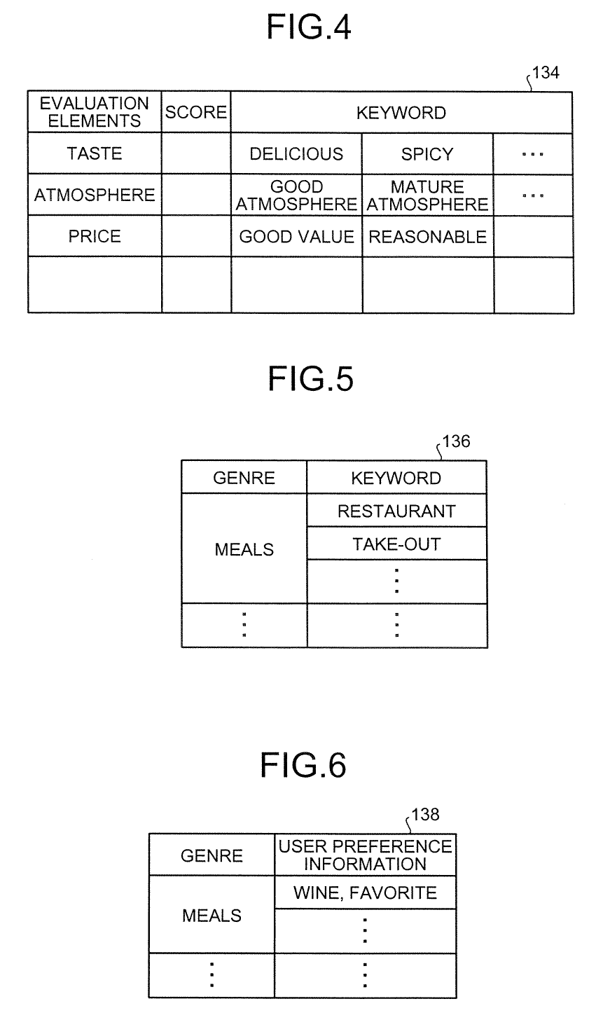

FIG. 4 is a schematic diagram of a data structure of an evaluation-element table 134 stored in the knowledge DB 130. In the present example, each evaluation element is an element that is used when an evaluation is made in the genre to which the keyword belongs. The evaluation elements shown in FIG. 4 are related to meals. The evaluation-element table 134 stores therein keywords each of which may be obtained from a user in correspondence with evaluation elements to which the keywords belong. Further, the evaluation-element table 134 stores therein search scores respectively corresponding to the evaluation elements. Of these evaluation elements, higher search scores are assigned to the evaluation elements to which higher importance should be attached. For example of this data structure, the keywords “delicious” and “spicy” belong to the evaluation element “taste”.

As explained above, in the evaluation-element table 134, each of the keywords is stored in correspondence with an evaluation element to which the keyword belongs. Thus, the special-search-criteria generating unit 124 generates the search criteria that have a different evaluation element and serve as the special search criteria being in correspondence with the obtained input search criteria, by referring to the evaluation-element table 134. Also, by referring to the search scores, the special-search-criteria generating unit 124 is able to generate special search criteria, based on an evaluation element that has a higher search score. As another example, the special-search-criteria generating unit 124 may generate special search criteria, using a different keyword that belongs to the same evaluation element.

FIG. 5 is a schematic diagram of a data structure of a genre table 136 stored in the knowledge DB 130. The genre table 136 stores therein keywords that each have a broader concept than the keywords stored in the evaluation-element table 134. As shown in the drawing, concepts that range from a broader concept to a more limited concept are divided into various genres in a hierarchical manner.

FIG. 6 is a schematic diagram of an example of a data structure of a preference table 138 stored in the knowledge DB 130. The preference table 138 stores therein genres in correspondence with pieces of user preference information. Each of the pieces of user preference information is stored in correspondence with the genre to which the piece of user preference information belongs. For example, when wine is the user's favorite, a piece of user information “wine, favorite” is stored in correspondence with the genre “meals” to which wine belongs.

The pieces of user preference information are registered in the preference table 138 in advance. Alternatively, another arrangement is acceptable in which pieces of user preference information are specified and registered, based on information such as search criteria that have been input to the information searching apparatus 10 by the user.

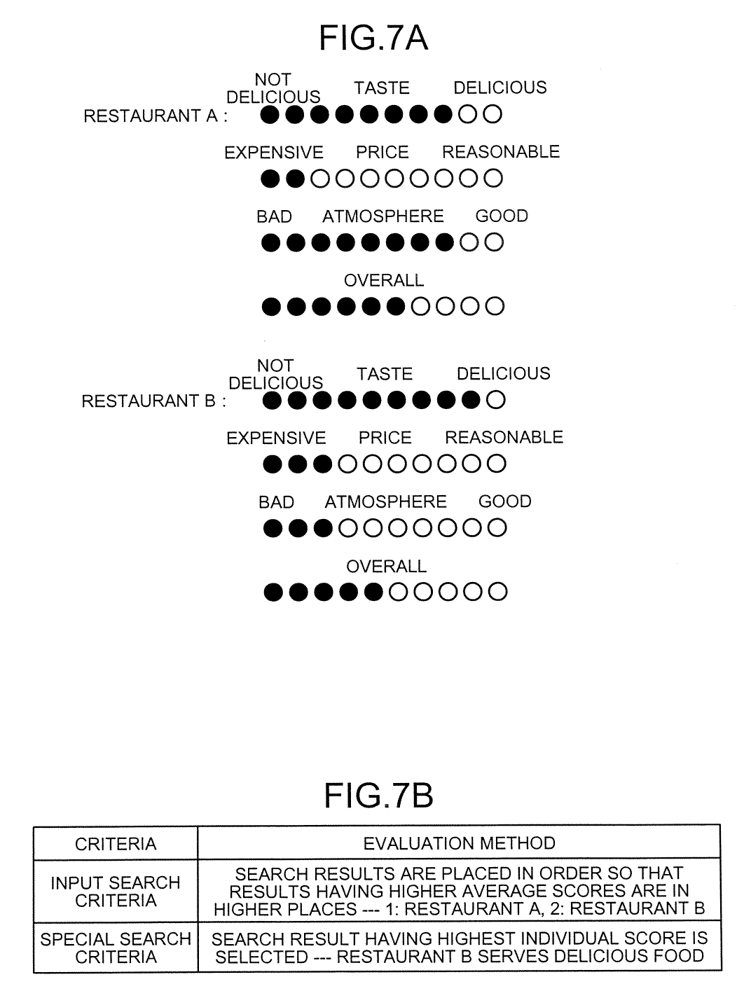

FIG. 7A and FIG. 7B are drawings for explaining a processing performed by the search-result evaluating unit 128. As shown in FIG. 7A, for example, the restaurants are extracted as search results. In this situation, together with the restaurants, the search conducting unit 126 also extracts, from the knowledge DB 130, the scores with respect to the attributes that are stored in correspondence with the restaurants. The search-result evaluating unit 128 then evaluates the search results, based on the extracted scores. Alternatively, another arrangement is acceptable in which a score with respect to an attribute is calculated so that the search results are evaluated based on the calculated scores.

FIG. 7B is a schematic diagram for explaining an evaluation method for the search results. As shown in FIG. 7B, for example, as for the search results based on the input search criteria, an average of the scores with respect to all of the attributes corresponding to the pieces of information is calculated. Accordingly, the search results are placed in order so that the search results having the higher average values are in the higher places. In other words, for the example shown in FIG. 7A, the restaurants are arranged in the following order: Restaurant A, and then Restaurant B.

On the other hand, as for the search results based on the special search criteria, a comparison is made so as to obtain the highest score of all the scores belonging to the attributes. In the example shown in FIG. 7A, the score for the taste at Restaurant B is “9” and is the highest. Thus, Restaurant B is selected as the search result based on the special search criteria. Further, the attribute “taste”, which has the highest score for Restaurant B, is selected. In other words, as for the search result based on the special search criteria, information indicating that “Restaurant B serves delicious food” is obtained.

As explained so far, it is possible to select search results that are based on mutually different perspectives, by using mutually different evaluation methods for the search results based on the input search criteria and the search results based on the special search criteria.

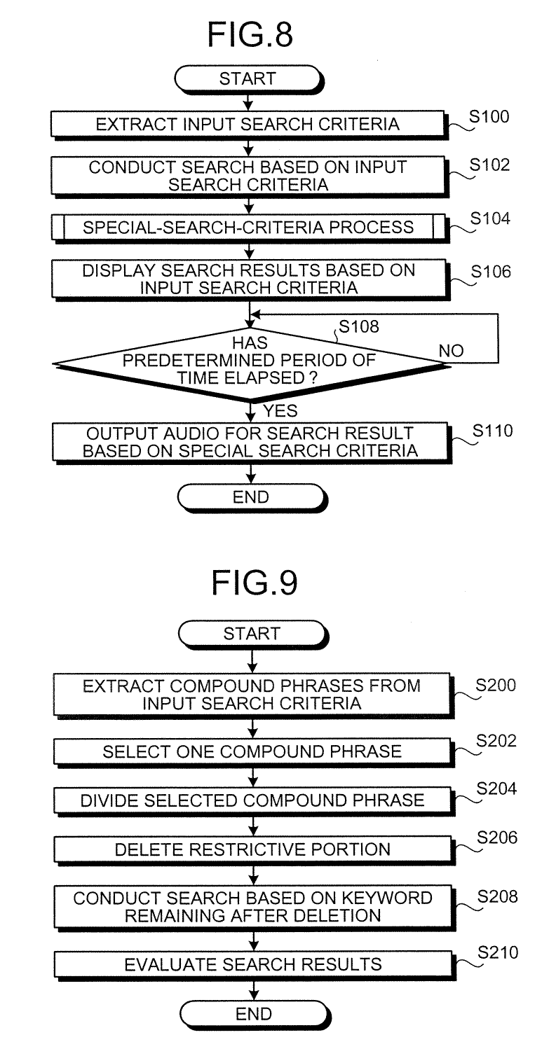

FIG. 8 is a flowchart of an information searching processing performed by the information searching apparatus 10. Firstly, the input-search-criteria extracting unit 122 extracts input search criteria from the information that has been input by a user (step S100). Next, the search conducting unit 126 conducts a search according to the input search criteria (step S102). Further, the search conducting unit 126 conducts a search according to special search criteria generated by the special-search-criteria generating unit 124 (step S104). Subsequently, search results that are obtained based on the input search criteria are displayed on the display screen 12 (step S106). To be more specific, the pieces of information that are found as the search results are placed in order by the search-result evaluating unit 128 so that a list of search results in which the search results are arranged in order is displayed on the display screen 12.

Further, when a predetermined period of time has elapsed after the search results based on the input search criteria are displayed (step S108: Yes), a search result based on the special search criteria is output in the form of audio (step S110). Thus, the information searching processing is completed. The timing at which the search based on the input search criteria and the search based on the special search criteria are conducted is not limited to the example used in the present embodiment. For example, these searches may be conducted in parallel. Alternatively, the search based on the special search criteria may be conducted before the search based on the input search criteria is conducted.

FIG. 9 is a flowchart of a detailed procedure in the special search criteria processing (step S104) explained with reference to FIG. 8. In FIG. 9, a processing to be performed when special search criteria are generated by extending input search criteria is illustrated.

Firstly, the special-search-criteria generating unit 124 extracts compound words included in the input search criteria extracted by the input-search-criteria extracting unit 122 (step S200). Then, the special-search-criteria generating unit 124 selects one compound word out of the extracted compound words (step S202). Subsequently, the special-search-criteria generating unit 124 divides the selected compound word into words (step S204). Of these words that have been obtained this way, restrictive portions, which denote the words that indicate restrictions, are deleted (step S206). Next, the search conducting unit 126 conducts a search, using what remains after deleting the restrictive portions from the compound word as special search criteria (step S208). Subsequently, the search-result evaluating unit 128 evaluates the search results (step S210). To evaluate the search results, as explained with reference to FIG. 7A and FIG. 7B, for example, after the contents that are duplicated in the search results based on the input search criteria are deleted, a piece of information that corresponds to the highest score is identified as a search result based on the special search criteria.

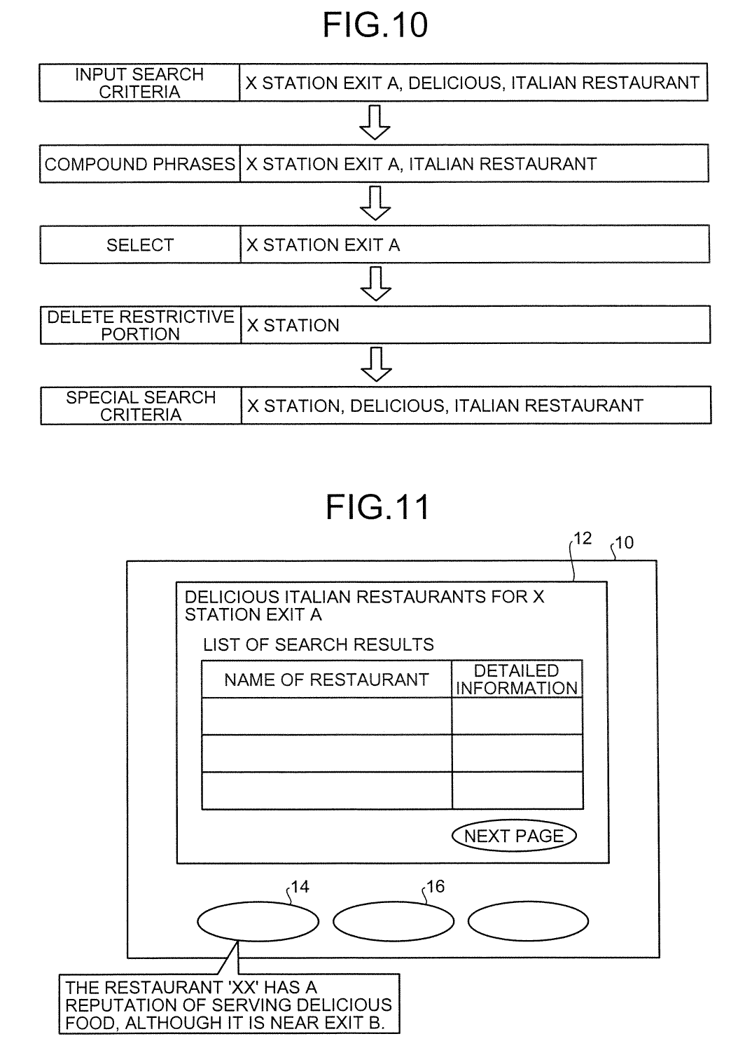

FIG. 10 is a schematic diagram of an example of the special search criteria processing (step S104). For example, let us assume that three keywords, namely “X Station Exit A”, “delicious”, and “Italian restaurant”, are obtained as input search criteria. In this situation, “X Station Exit A” and “Italian restaurant” are extracted as compound words. In the present example, “X Station Exit A” is selected. Subsequently, the restrictive portion “Exit A” is deleted. Thus, “X Station” is obtained. As a result of the processing described here, special search criteria that include the three keywords, namely “X Station”, “delicious”, and “Italian restaurant”, are obtained.

FIG. 11 is a schematic diagram of search results obtained from the example shown in FIG. 10. A list of search results based on the input search criteria shown in FIG. 10 is displayed on the display screen 12, as shown in FIG. 11. As shown in the drawing, because the search results based on the input search criteria are displayed in the form of a list, it is possible to view the plurality of pieces of information while comparing them.

In addition, as a search result obtained based on the special search criteria shown in FIG. 10, there is an audio output from the speaker 14 saying “The restaurant ‘XX’ has a reputation of serving delicious food, although it is near Exit B”. As shown in this example, it is possible to inform the user that there is a restaurant having a reputation of serving delicious food near Exit B, which is not very far from Exit A, even if the geographical criterion of the restaurant does not satisfy the input search criteria.

When conducting a search, the user does not necessarily specify the search criteria always carefully. Thus, it is more likely to be able to offer some responses that are interesting to the user, by offering a search result based on the special search criteria that include partially different criteria from the input search criteria.

Further, as explained above, the search result that does not satisfy the input search criteria is output in the form of audio, which is an output form different from the one used to output the search results based on the input search criteria. Thus, it is possible to avoid the situation where it is difficult to understand which one of the search results is based on the input search criteria.

In addition, in the situation above, it is desirable that the audio output includes the information indicating that the search result does not satisfy the input search criteria. For example, it is desirable that the audio output includes the phrase “although it is near Exit B”. With this arrangement, it is possible to prevent the user from getting confused. Also, it is desirable that the audio output includes the information indicating based on what special search criterion (i.e. based on what attribute) the search result has been selected. For example, it is desirable that the audio output includes the word indicating the special search criterion “delicious”. With this arrangement, the user is able to judge whether the search result is what he/she is looking for.

If the user is interested in the search result output in the form of audio, the user can speak into the microphone 16, saying “I'd like to know more about it.” When having obtained such audio information, the interaction processing unit 110 may display, on the display screen 12, more detailed information of the contents of the audio output. On the other hand, if the user is not interested in the information provided in the audio output, he/she may ignore it.

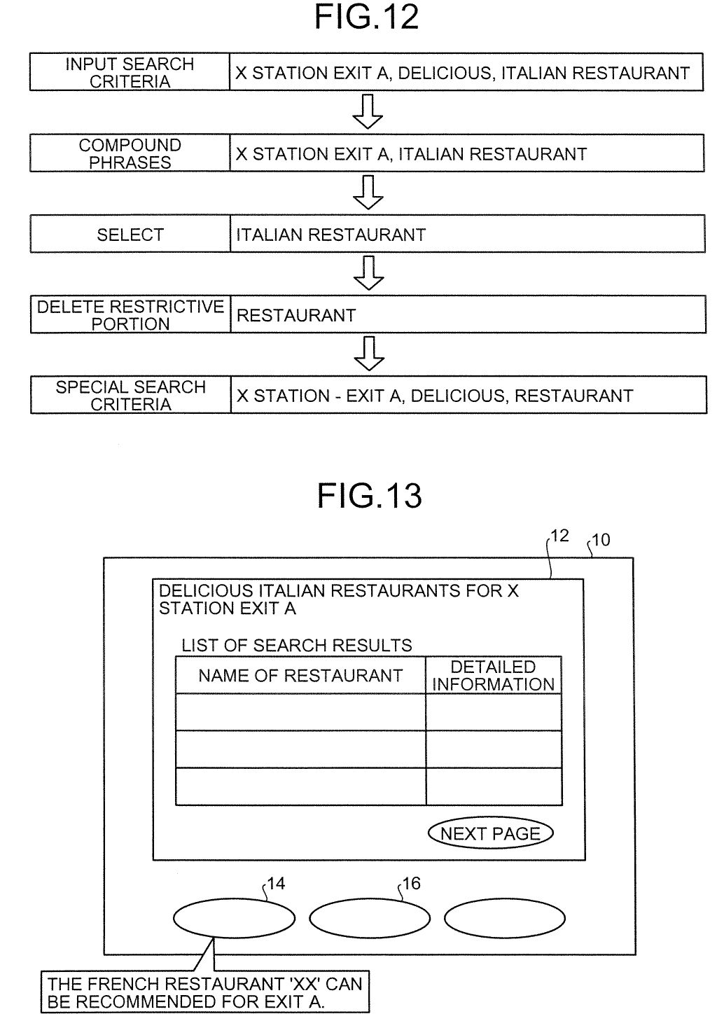

FIG. 12 is a schematic diagram of an example obtained by deleting a different restrictive portion from input search criteria that are the same as the input search criteria shown in FIG. 10. In the example shown in FIG. 12, “Italian restaurant” is selected out of the compound words. Subsequently, “Italian” is deleted from the compound word, to obtain “restaurant”. As a result, special search criteria that include the three keywords, namely “X Station Exit A”, “delicious”, and “restaurant”, are obtained.

FIG. 13 is a schematic diagram of search results obtained from the example shown in FIG. 12. On the display screen 12, the contents that are the same as the ones shown in FIG. 11 are displayed in a list. In addition, as a search result based on the special search criteria shown in FIG. 12, there is an audio output from the speaker 14 saying “The French restaurant ‘XX’ can be recommended for Exit A”. In this situation also, it is desirable that the audio output includes the information indicating that the search result does not satisfy the input search criteria. For example, it is desirable that the audio output includes the word “French”.

As shown in this example, it is acceptable to have an arrangement in advance so that the compound word from which the restrictive portion is deleted is the keyword that has been input first among the keywords. Alternatively, it is also acceptable to select the compound word from which the restrictive portion is deleted in a random manner. Furthermore, it is acceptable to delete the restrictive portion from each of all the compound words included in the keywords.

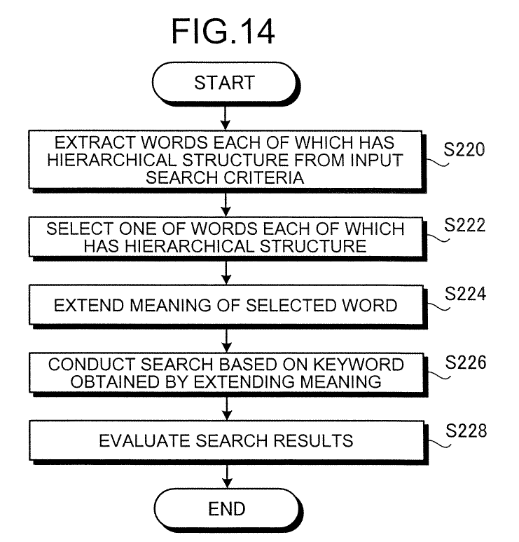

FIG. 14 is a flowchart of a detailed procedure in the special search criteria processing (step S104) during which special search criteria are generated by extending the meaning of a keyword included in the input search criteria. Firstly, the special-search-criteria generating unit 124 extracts words each of which has a hierarchical structure from the input search criteria (step S220). In this situation, the “words each of which has a hierarchical structure” denote the keywords that have been registered in the extended-keyword table 132.

Next, the special-search-criteria generating unit 124 selects a word out of the extracted words each of which has a hierarchical structure (step S222). Subsequently, by referring to the extended-keyword table 132, the special-search-criteria generating unit 124 extends the meaning of the selected word that has a hierarchical structure (step S224). Then, the search conducting unit 126 conducts a search, based on special search criteria that includes the keyword obtained by extending the meaning (step S226). Then, the search-result evaluating unit 128 evaluates the search results (step S228). Thus, the special search criteria processing (step S104) is completed.

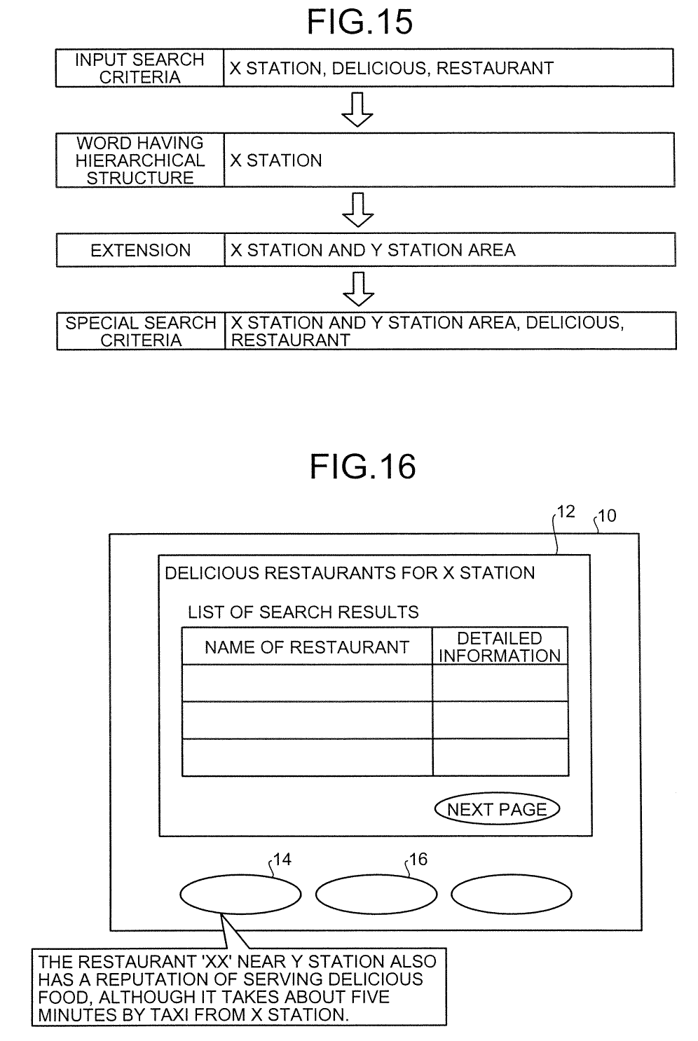

FIG. 15 is a schematic diagram of an example of the special search criteria processing (step S104) during which special search criteria are generated by extending the meaning of a keyword. Let us assume that three key words, namely “X Station”, “delicious”, and “restaurant”, are obtained as input search criteria. In this situation, “X Station”, which has been registered as one of the keywords in the extended-keyword table 132, is selected. Subsequently, the meaning of the keyword “X Station” is extended to the extended keyword “X Station and Y Station area” that is stored in correspondence with “X Station” in the extended-keyword table 132. As a result of the processing described here, special search criteria that include the three keywords, namely “X Station and Y Station area”, “delicious”, and “restaurant”, are obtained.

FIG. 16 is a schematic diagram of search results obtained from the example shown in FIG. 15. A list of search results based on the input search criteria shown in FIG. 15 is displayed on the display screen 12. In addition, as a search result based on the special search criteria, there is an audio output saying “The restaurant ‘XX’ near Y Station also has a reputation of serving delicious food, although it takes about five minutes by taxi from X Station.” As explained in this example, it is possible to output, in the form of audio, the search result obtained by slightly extending the range of the search.

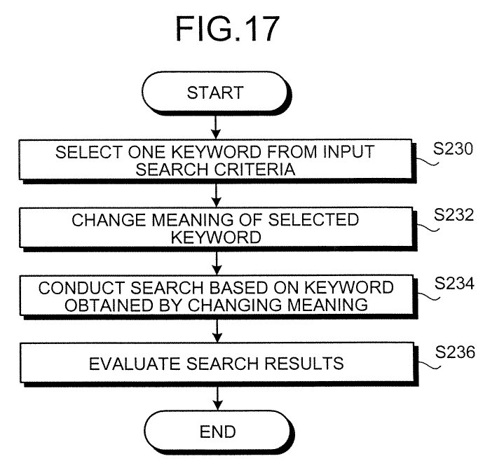

FIG. 17 is a flowchart of a detailed procedure in the special search criteria processing (step S104) during which special search criteria are generated by changing the meaning of a keyword included in the input search criteria. Firstly, the special-search-criteria generating unit 124 selects one keyword out of input search criteria (step S230). Next, the special-search-criteria generating unit 124 changes the meaning of the selected keyword (step S232). To be more specific, the special-search-criteria generating unit 124 changes the selected keyword to another keyword that is in correspondence with a genre different from the genre to which the selected keyword belongs, by referring to the genre table 136.

Next, a search is conducted based on the special search criteria that include the keyword obtained by changing the meaning (step S234). Subsequently, the search results are evaluated (step S236). Thus, the special search criteria processing (step S104) is completed.

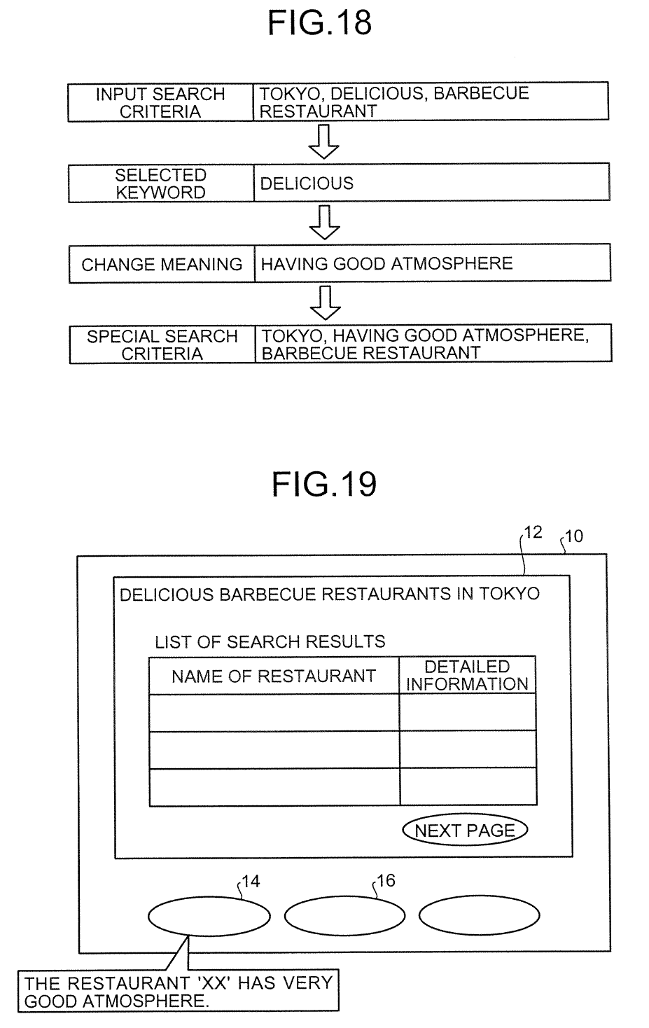

FIG. 18 is a schematic diagram of an example of the special search criteria processing (step S104) during which special search criteria are generated by changing the meaning of a keyword. Let us assume that three keywords, namely “Tokyo”, “delicious”, and “barbecue restaurant”, are obtained as input search criteria. In this example, one adjective keyword is selected. In other words, “delicious” is selected. Next, by referring to the genre table 136, another keyword “having good atmosphere” that belongs to a genre of “atmosphere”, which is different from the genre to which “delicious” belongs, is selected. Thus, the meaning of the keyword has been changed. As a result of the processing described here, special search criteria that include the three keywords, namely “Tokyo”, “having good atmosphere”, and “barbecue restaurant”, are obtained.

FIG. 19 is a schematic diagram of search results obtained from the example shown in FIG. 18. A list of search results based on the input search criteria shown in FIG. 18 is displayed on the display screen 12. In addition, as a search result obtained based on the special search criteria, there is an audio output saying “The restaurant ‘XX’ has very good atmosphere.” As described here, it is possible to output, in the form of audio, a search result from a different perspective. As shown in this example, it is preferable to select an adjective as a keyword, in view of making the point of perspective different.

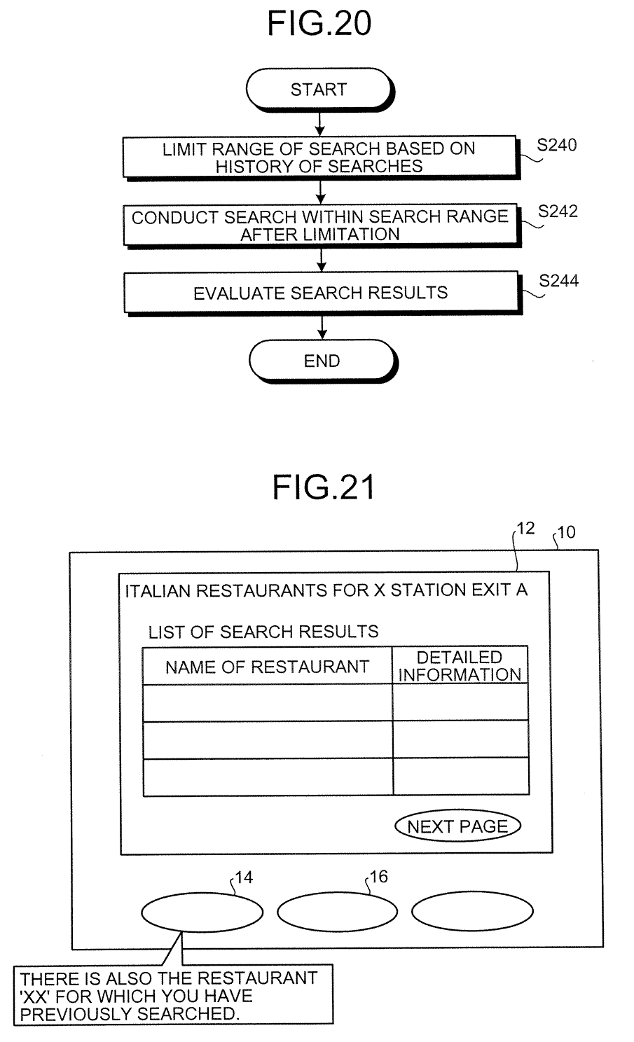

FIG. 20 is a flowchart of a detailed procedure in the special search criteria processing (step S104) during which a special search is conducted using a search history as a search target. Firstly, the special-search-criteria generating unit 124 limits a search range to a search history stored in the knowledge DB 130 (step S240). To be more specific, for example, the special-search-criteria generating unit 124 limits the search range to the contents of the search history that indicates a history of searches conducted by the user. Next, a search is conducted based on the special search criteria, using the search range obtained after the limitation as the target of the search (step S242). Subsequently, the search results are evaluated (step S244). Thus, the special search criteria processing (step S104) is completed.

In this processing, there is a high possibility that the search results based on the input search criteria are duplicated in the search results based on the special search criteria. When some of the search results based on the special search criteria are duplicated in the search results based on the input search criteria, the rest of the search results based on the special search criteria that are not duplicated are output in the form of audio. Alternatively, another arrangement is acceptable in which, out of the search results that are not duplicated, a search result that has the highest score is output in the form of audio. Further alternatively, another arrangement is acceptable in which, when the search results are duplicated, it is considered that there is no corresponding information, and therefore no audio is output.

FIG. 21 is a schematic diagram of an example of the special search criteria processing (step S104) during which a special search is conducted using a search history as a search target. When two keywords, namely “X station Exit A” and “Italian restaurant”, are obtained as input search criteria, a list as shown in FIG. 21 is displayed on the display screen 12. In addition, as a search result based on a search history, there is an audio output saying “There is also the restaurant ‘XX’ for which you have previously searched.” As explained in this example, it is possible to output a search result based on the search history.

When a special search is conducted using the search history as the search target, it is also acceptable to use various types of other information including information of places that have been visited by the user that is registered as the user's schedule in the user information.

Further, as another example, it is also acceptable to combine the processing of generating the special search criteria by limiting the search target range to a previous search history, which has been explained with reference to FIG. 20, with the processing of generating the special search criteria by extending the input search criteria, which has been explained with reference to FIG. 9.

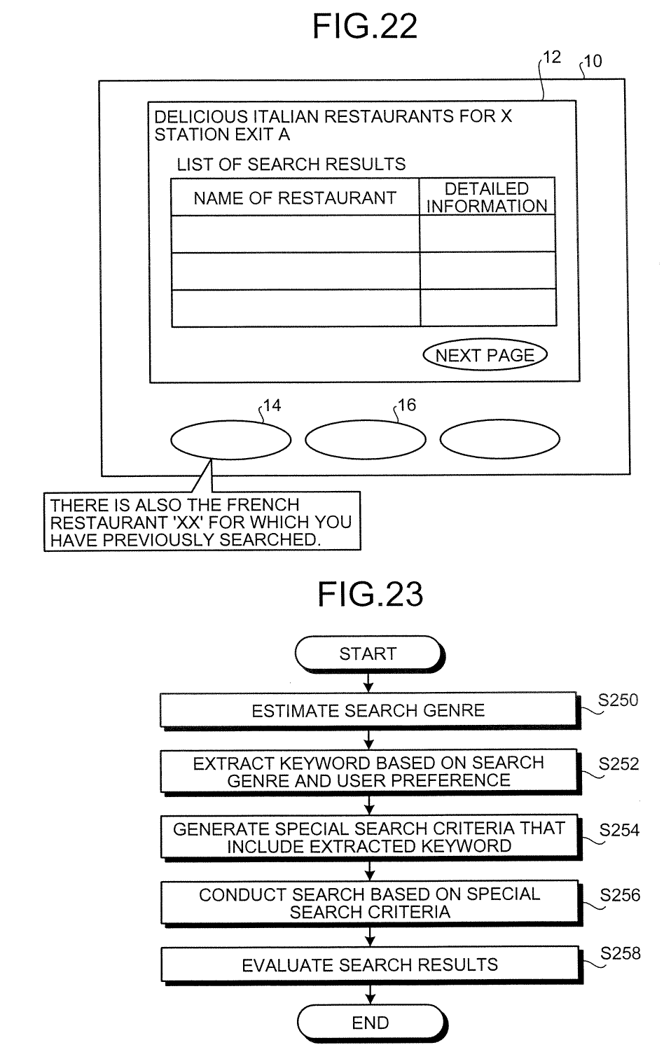

FIG. 22 is a schematic diagram of results of a search conducted by using a previous search history as a search target, and also based on special search criteria obtained by extending input search criteria. Let us assume that “X station Exit A”, “delicious”, and “Italian restaurant” are obtained as input search criteria. In this situation, a list of search results based on these input search criteria is displayed on the display screen 12. Further, of the input search criteria, “Italian restaurant” is extended to “restaurant”. Then, a search is conducted based on these special search criteria, while the previous search history of the user is used as the search target. As a search result based on the special search criteria, there is an audio output saying “There is also the French restaurant ‘XX’ for which you have previously searched.”

FIG. 23 is a flowchart of a detailed procedure in the special search criteria processing (step S104) during which special search criteria are generated based on a user's preference. Firstly, the special-search-criteria generating unit 124 estimates a search genre based on input search criteria (step S250). To be more specific, the special-search-criteria generating unit 124 identifies a genre that is in correspondence with a keyword included in the input search criteria, by referring to the genre table 136.

Next, the special-search-criteria generating unit 124 extracts a keyword, based on the search genre and the user's preference registered in the knowledge DB 130 as the user information (step S252). To be more specific, the special-search-criteria generating unit 124 extracts, as the keyword, a user's preference that is stored in correspondence with the search genre, by referring to the preference table 138.

Subsequently, the special-search-criteria generating unit 124 puts the extracted keyword into the input search criteria so as to obtain special search criteria (step S254). Then, a search is conducted, based on the special search criteria (step S256). In this situation, it is acceptable to add a weight that is to be reflected on the search score to the keyword that has been added from the user information so that the keyword is considered to be more important than other keywords. Then, the search results are evaluated (step S258). Thus, the special search criteria processing (step S104) is completed.

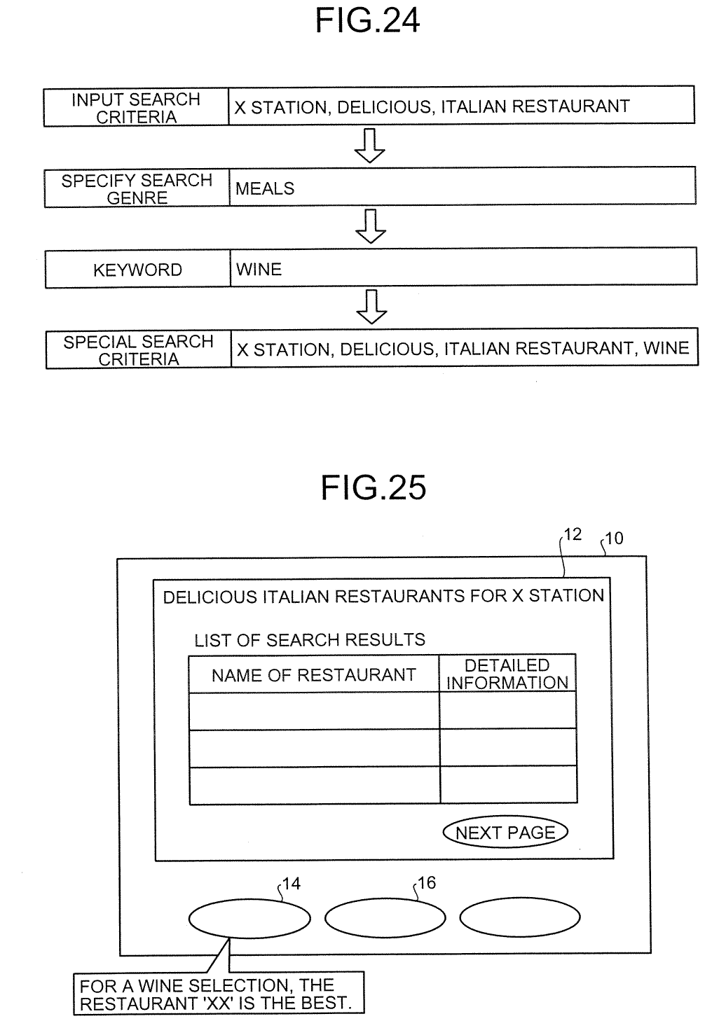

FIG. 24 is a schematic diagram of an example of a processing for generating special search criteria based on a user's preference. Let us assume that three keywords, namely “X Station”, “delicious”, and “Italian restaurant”, are obtained as input search criteria. Further, with reference to the genre table 136, the genre of “Italian restaurant” is estimated as “meals”. Next, with reference to the preference table 138, a user's preference “wine” that is in correspondence with the genre “meals” is identified and extracted as a keyword. The keyword “wine” extracted this way is added to the search criteria. As a result of the processing described here, special search criteria that include the four keywords, namely “X station”, “delicious”, “Italian restaurant”, and “wine”, are generated.

FIG. 25 is a schematic diagram of search results obtained from the example shown in FIG. 24. A list of search results based on the input search criteria is displayed on the display screen 12. In addition, as a search result based on the special search criteria, there is an audio output from the speaker 14 saying “For a wine selection, the restaurant ‘XX’ is the best.” As explained in this example, it is possible to also inform the user of a search result that is obtained by adding a criterion to suit the user's preference.

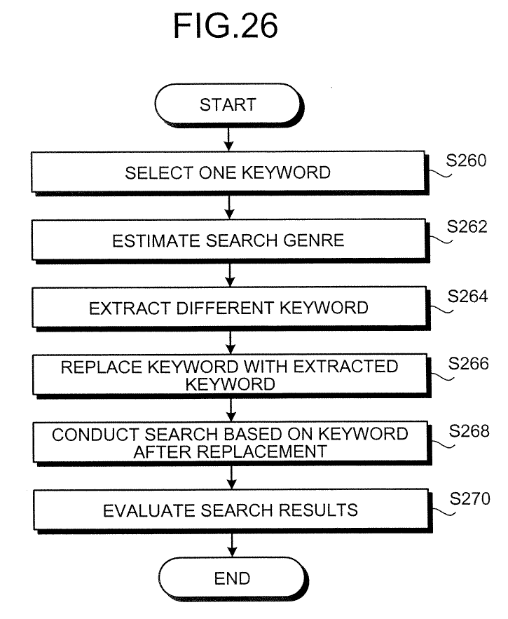

FIG. 26 is a flowchart of a detailed procedure in the special search criteria processing (step S104) during which special search criteria are generated by changing a keyword included in the input search criteria. Firstly, the special-search-criteria generating unit 124 selects one of the keywords included in input search criteria (step S260). The search genre is estimated based on the selected keyword (step S262). To be more specific, the genre that is stored in correspondence with the keyword is identified, with reference to the genre table 136.

Next, another keyword that belongs to the identified genre and is different from the keywords included in the input search criteria is extracted (step S264). Subsequently, the keyword selected out of the input search criteria is replaced with the keyword extracted from the genre table 136 (step S266). Then, a search is conducted based on the special search criteria that include the keyword after the replacement (step S268). Subsequently, the search results are evaluated (step S270). Thus, the special search criteria processing (step S104) is completed.

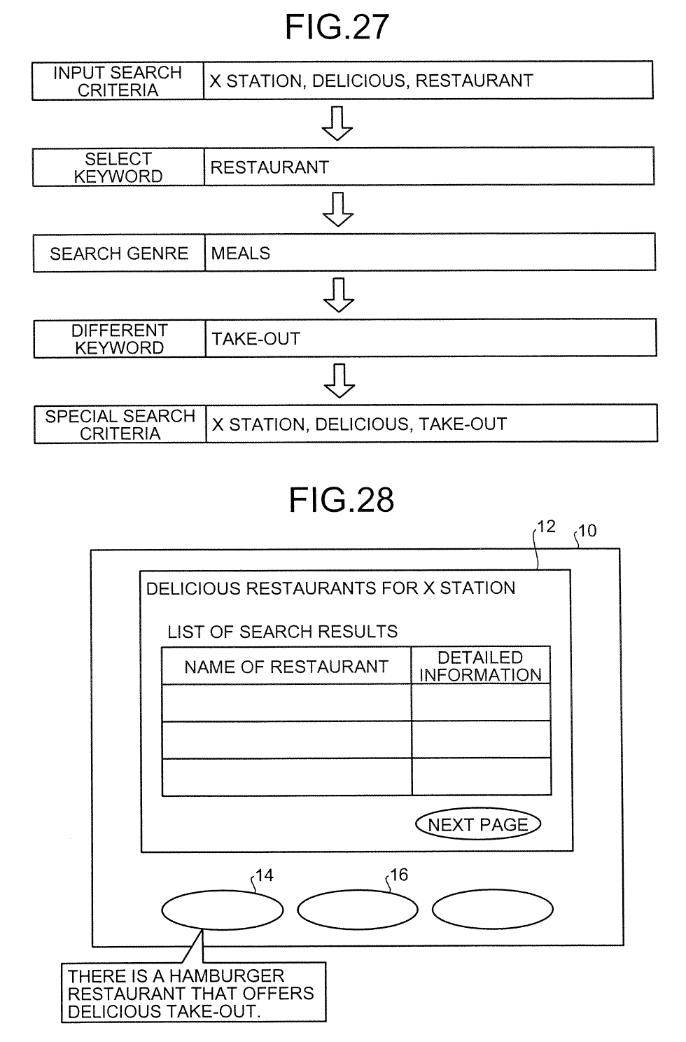

FIG. 27 is a schematic diagram of an example of a processing for generating special search criteria by changing a keyword included in input search criteria. Let us assume that three key words, namely “X station”, “delicious”, and “restaurant”, are obtained as input search criteria. In this example, “restaurant” is selected. Next, with reference to the genre table 136, the search genre of the selected keyword “restaurant” is estimated as “meals”. Subsequently, “take-out” is extracted as a keyword that belongs to the search genre “meals” and is different from “restaurant”. By replacing “restaurant” included in the input search criteria with “take-out”, special search criteria that include the three keywords, namely “X Station”, “delicious”, and “take-out”, are obtained.

FIG. 28 is a schematic diagram of search results obtained from the example shown in FIG. 27. A list of search results based on the input search criteria is displayed on the display screen 12. In addition, as a search result based on the special search criteria, there is an audio output from the speaker 14 saying “There is a hamburger restaurant that offers delicious take-out.”

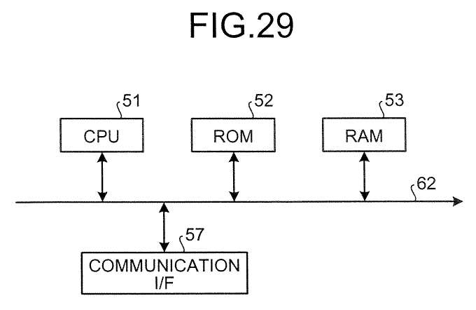

FIG. 29 is a schematic diagram of a hardware configuration of the information searching apparatus 10 according to the present embodiment. As the hardware configuration, the information searching apparatus 10 includes a Read Only Memory (ROM) 52 that stores therein, for example, an information searching program for having the information searching processing executed by the information searching apparatus 10, a Central Processing Unit (CPU) 51 that controls the constituent elements of the information searching apparatus 10 according to the program stored in the ROM 52, a Random Access Memory (RAM) 53 that stores therein various pieces of data that are necessary for controlling the information searching apparatus 10, a communication interface (I/F) 57 that is connected to a network and performs communication, and a bus 62 that connects these elements to one another.

The information searching program that is described above and is used in the information searching apparatus 10 may be provided as being recorded on a computer-readable recording medium like a Compact Disk Read Only Memory (CD-ROM), a Floppy (R) Disk (FD), or a Digital Versatile Disk (DVD), in a file that is in an installable format or in an executable format.

In such a situation, the information searching program is loaded onto a main storage device when being read from the recording medium and executed in the information searching apparatus 10. Thus, the constituent elements described in the software configuration above are generated in the main storage device.

Also, the information searching program according to the present embodiment may be stored in a computer connected to a network like the Internet and provided as being downloaded via the network.

So far, the present invention has been explained through the description of the present embodiment. However, it is also acceptable to apply various modifications and improvements to the present embodiment described above.

A first modification example can be explained as follows: According to the present embodiment described above, the search result based on the special search criteria is output, in the form of audio, from the speaker 14 when a predetermined period of time has elapsed after the list of the search results based on the input search criteria is displayed on the display screen 12; however, the timing at which the audio is output is not limited to this example. For example, the search result based on the special search criteria may be output, in the form of audio, from the speaker 14 at the same time when the search results based on the input search criteria are displayed on the display screen 12. Alternatively, another arrangement is acceptable in which audio is output when the user instructs that a page should be turned in the screen display, in other words, when the user instructs that the display should be switched. In this situation, because it is likely that the user instructs that the page should be turned when a list does not include what the user is looking for, the different piece of information is provided at this timing. The instruction indicating that the display should be switched is obtained by the I/O control unit 100. In other words, the I/O control unit 100 functions as a user instruction obtaining unit.

As another example, if a user shows a reaction indicating that he/she has obtained information he/she is looking for, for example, by saying “I like this one” while a list of search results is displayed on the display screen 12, or when a user instructs that detailed information of the contents of the displayed list should be further displayed, it is acceptable not to have any audio output on an assumption that no more additional information is necessary.

A second modification example is to display, after a search result is output in the form of audio, detailed information of the contents of the audio output on the display screen 12, if it is understood that the user is interested in the search result in the audio output, for example if the user shows a reaction indicating that he/she has obtained information that he/she is looking for, by saying “I like this one”. On the contrary, if it is not understood that the user is interested in the contents of the audio output, the search result based on the special search criteria may be deleted also from the history stored in the user information.

A third modification example can be explained as follows: According to the present embodiment, the search results based on the input search criteria are output in the form of an image, and the search result based on the special search criteria is output in the form of audio. However, it is acceptable to use any forms as long as the user is able to distinguish the search results based on the input search criteria from the search result based on the special search criteria. The forms in which the search results are output are not limited to the examples used in the description of the present embodiment.

A fourth modification example is to output a message, in the form of audio, indicating that there is information that satisfies special search criteria, instead of outputting the search results, in the form of audio, based on the special search criteria. With this arrangement, it is possible to avoid providing user with too much information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for searching information, the apparatus comprising:
a first acquiring unit that acquires a first search criterion from outside;
a first storing unit that stores information to be searched;
a first searching unit that extracts a first search result that satisfies the first search criterion from the first storing unit;
a first output unit that outputs the first search result to a first output device;
a changing unit that changes the first search criterion to a second search criterion based on a predetermined condition;
a second searching unit that extracts a second search result that satisfies the second search criterion from the first storing unit; and
a second output unit that outputs the second search result to a second output device having an output style different from an output style of the first output device.

2. The apparatus according to claim 1, further comprising:
a specifying unit that specifies information to be output by the second output unit out of the second search result, based on the first search result and the second search result, wherein
the second output unit outputs the information specifies by the specifying unit to the second output device as the second search result.

3. The apparatus according to claim 1, further comprising:
a calculating unit that, when a plurality of pieces of information are obtained as the second search result, calculates a search score for each of the pieces of information; and
a specifying unit that specifies information to be output by the second output unit out of the second search result, based on the search score, wherein
the second output unit outputs the information specifies by the specifying unit to the second output device as the second search result.

4. The apparatus according to claim 1, wherein
the predetermined condition is that the second search criterion has a broader search range than the first search criterion.

5. The apparatus according to claim 4, wherein
the first search criterion is a compound word, and
the predetermined condition is to delete, from the compound word, a word that represents a limitation included in the compound word.

6. The apparatus according to claim 1, wherein
the predetermined condition that is that the second search criterion has a broader search range than the first search criterion, and that the second search criterion is a different type of search criterion from the first search criterion.

7. The apparatus according to claim 1, wherein
the predetermined condition that is that the second search criterion has a narrower search range than the first search criterion.

8. The apparatus according to claim 1, further comprising:
a second storing unit that stores the first search criterion and the second search criterion in a corresponding manner, wherein
the changing unit changes the first criterion to the second criterion corresponding to the first search criterion stored in the second storing unit.

9. The apparatus according to claim 1, wherein
the first output unit outputs the first search result to a display device, and
the second output unit outputs the second search result to an audio output device.

10. The apparatus according to claim 1, wherein
the second output unit outputs information indicating that the second search result is a result for the second search criterion, together with the second search result.

11. The apparatus according to claim 1, wherein
the second output unit outputs the second search result at the same time as the first output unit outputs the first search result.

12. The apparatus according to claim 1, wherein
the second output unit outputs the second search result in a predetermined time after the first output unit outputs the first search result.

13. The apparatus according to claim 1, further comprising:
a second acquiring unit that acquires an instruction for switching a display output by the first output unit from a user, wherein
the second output unit outputs the second search result when the instruction is acquired.

14. A method of searching information, the method comprising:
acquiring a first search criterion from outside;
extracting a first search result that satisfies the first search criterion from a storing unit that stores information to be searched;
outputting the first search result to a first output device;
changing the first search criterion to a second search criterion based on a predetermined condition;
extracting a second search result that satisfies the second search criterion from the storing unit; and
outputting the second search result to a second output device having an output style different from an output style of the first output device.

15. A computer program product having a computer readable medium including programmed instructions, wherein the instructions, when executed by a computer, cause the computer to perform:
acquiring a first search criterion from outside;
extracting a first search result that satisfies the first search criterion from a storing unit that stores information to be searched;
outputting the first search result to a first output device;
changing the first search criterion to a second search criterion based on a predetermined condition;
extracting a second search result that satisfies the second search criterion from the storing unit; and
outputting the second search result to a second output device having an output style different from an output style of the first output device.
